(19) United States
(12) Patent Application Publication
(10) Pub. No.: US 2026/0091745 A1
(43) Pub. Date: Apr. 2, 2026

(54) GROUND SYSTEM FOR AN INTEGRATED MODULE OF A VEHICLE

(71) Applicants: HYUNDAI MOTOR COMPANY, Seoul (KR); KIA CORPORATION, Seoul (KR)

(72) Inventors: Yong Han Lee, Hwaseong-si (KR); Byeong Gu Kang, Hwaseong-si (KR); Yeong Kwang Cho, Hwaseong-si (KR)

(73) Assignees: HYUNDAI MOTOR COMPANY, Seoul (KR); KIA CORPORATION, Seoul (KR)

(21) Appl. No.: 19/083,070

(22) Filed: Mar. 18, 2025

(30) Foreign Application Priority Data
Sep. 30, 2024 (KR) 10-2024-0133053

(51) Int. Cl. B60R 16/03

(52) U.S. Cl. CPC B60R 16/03

(57) ABSTRACT

according to embodiments of the present disclosure includes: a main bracket configured to support the integrated module; a ground bushing configured to connect to a ground wire extending from the integrated module; and a ground bolt configured to conductively connect the ground bushing to a vehicle body.

### CROSS-REFERENCE TO RELATED APPLICATION

This application is based on and claims the benefit of priority to Korean Patent Application No. 10-2024-0133053, filed on Sep. 30, 2024, in the Korean Intellectual Property Office, the disclosure of which is incorporated herein in its entirety by reference.

### TECHNICAL FIELD

The present disclosure relates to a ground (or grounding) system for an integrated vehicle module (or an integrated module for a vehicle), and more particularly, to a ground system for an integrated vehicle module designed to have a simple ground structure, thereby improving workability and reducing the cost and weight thereof.

### BACKGROUND

A vehicle may include an integrated module in which a plurality of components are integrated to perform a specific function. The integrated module may have the following effects: reduction in the number of components, productivity improvement, and cost reduction. The integrated module may include various electric/electronic components, and a ground system provided to ground the electric/electronic components. The ground system may be configured to improve electromagnetic compatibility (EMC) of the electric/electronic components, and remove electromagnetic noise.

For example, the vehicle may be provided with a coolant system for cooling a battery, a power electronics (PE) system, and the like. The vehicle may also be provided with a coolant hub module disposed in a front portion of the vehicle, in which various components such as an electric water pump, a valve, and a driver required in the coolant system are integrated. The coolant hub module may be mounted on a vehicle body through a main bracket, and the electric/electronic components of the coolant hub module may be grounded to the main bracket through a ground wire.

However, the main bracket may be made of galvanized steel, so it may be relatively difficult to conduct electricity. Since the volume of the main bracket is limited, EMC of the electric/electronic components may be reduced, and there may be a limitation in eliminating electromagnetic noise. To solve these problems, when the ground wire is directly connected to the vehicle body, the length of the ground wire may be increased, and workability thereof may be reduced.

The above information described in this background section is provided to assist in understanding the background of the inventive concept, and may include any technical concept which is not considered as the prior art that is already known to those having ordinary skill in the art.

### SUMMARY

The present disclosure has been made to solve the above-mentioned problems occurring in the prior art while advantages achieved by the prior art are maintained intact.

An aspect of the present disclosure provides a ground system for an integrated vehicle module designed to have a simple ground structure for electric/electronic components of the integrated module, thereby improving workability and reducing the cost and weight thereof.

According to an aspect of the present disclosure, a ground system for an integrated module of a vehicle may include: a main bracket supporting or configured to support the integrated module; a ground bushing connected to or configured to connect to a ground wire extending from the integrated module; and a ground bolt conductively connecting or configured to conductively connect the ground bushing to a vehicle body. Another aspect of the present disclosure provides a vehicle that includes such integrated module and ground system.

The ground bushing may include a cylindrical portion having a hole defined therein, a head portion provided on an end (e.g., a top end) of the cylindrical portion, and a connector coupled to or integrally formed with the head portion. An end of the ground wire may be coupled to or fixed to the connector.

A screw portion of the ground bolt may extend or may be configured to extend through the hole of the ground bushing, and a head portion of the ground bolt may contact or may be configured to contact the head portion of the ground bushing.

The ground system may further include a ground nut conductively connected to, or configured to conductively connected to, the vehicle body, and a screw portion of the ground bolt may be screwed into, or configured to be screwed into, the ground nut.

The ground nut may include a cylindrical portion and a head portion provided on a top end of the cylindrical portion. The ground bushing may contact, or be configured to contact, the head portion of the ground nut.

The ground system may further include an insulator enclosing or configured to enclose an outer surface of a cylindrical portion of the ground bushing. The insulator may be mounted on, or configured to mount on or to, the main bracket.

The ground system may further include a support bracket configured to support the main bracket. The support bracket may be fixed to, or configured to be coupled to, the vehicle body, and the ground nut may be fixed to, or configured to be coupled to, the support bracket.

The ground nut may be directly fixed to, or configured to be directly fixed or coupled to, the vehicle body.

### BRIEF DESCRIPTION OF THE DRAWINGS

The above and other objects, features and advantages of the present disclosure should be more apparent from the following detailed description taken in conjunction with the accompanying drawings:

FIG. 1 illustrates a perspective view of a ground system according to an embodiment of the present disclosure, which is applied to an integrated module of a vehicle;

FIG. 2 illustrates a perspective view of the ground system mounted on a portion of the integrated module of FIG. 1;

FIG. 3 illustrates a perspective view of a ground bushing of a ground system according to an embodiment of the present disclosure;

FIG. 4 illustrates a cross-sectional view, taken along line A-A of FIG. 2; and

FIG. 5 illustrates a cross-sectional view of a ground system according to another embodiment of the present disclosure.

### DETAILED DESCRIPTION

Hereinafter, embodiments of the present disclosure are described in detail with reference to the accompanying drawings. In the drawings, the same reference numerals are used throughout to designate the same or equivalent elements. In addition, a detailed description of well-known techniques associated with the present disclosure have been omitted in order not to unnecessarily obscure the gist of the present disclosure.

Terms such as first, second, A, B, (a), and (b) may be used to describe the elements in embodiments of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application. When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

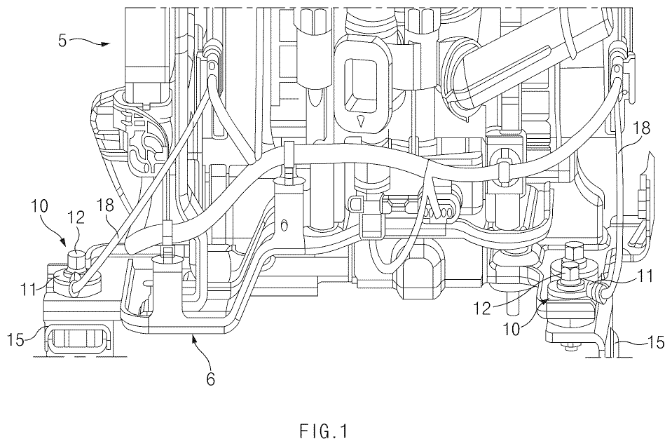

Referring to FIG. 1, a ground system 10 according to an embodiment of the present disclosure may be configured to allow electric/electronic components of an integrated module 5 to be grounded to a vehicle body. As the vehicle body is made of a conductor material such as steel, it may serve as a reference potential with a relatively constant distribution of electric charges. As the vehicle body has a relatively large area, it may be a relatively bulky conductor.

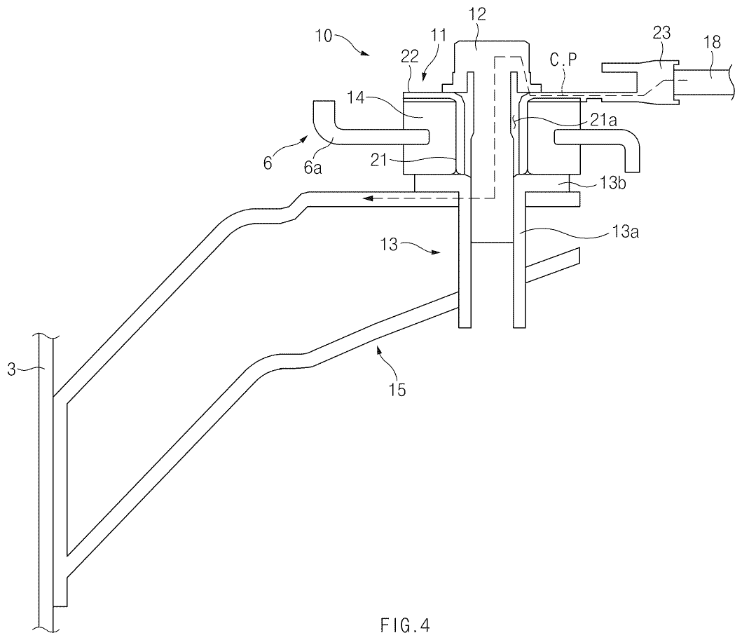

Referring to FIG. 4, the integrated module 5 may be supported by a main bracket 6, and the main bracket 6 may be supported to a portion of a vehicle body 3 (for example, a front side member) through a plurality of support brackets 15. Since the main bracket 6, which may be a highly anti-rust component, may be made of galvanized steel, it may be relatively difficult to conduct electricity, and the volume of the main bracket 6 may be limited. The main bracket 6 may be coupled or fixed to the support brackets 15 via fasteners, and the support brackets 15 may be coupled or fixed to a portion of the vehicle body 3 using fasteners, welding, and/or the like. The support brackets 15 may be made of a conductor material which is the same as or similar to that of the vehicle body 3. The support brackets 15 may be conductively connected to the vehicle body 3. For example, the integrated module 5 may be a coolant hub module in which various components such as an electric water pump, a valve, and a driver are integrated. The coolant hub module may be provided to a coolant system for cooling a battery, a power electronics (PE) system, and the like, and the coolant hub module may be disposed in a front compartment of the vehicle.

The ground system 10 according to an embodiment of the present disclosure may be configured to allow a ground wire 18 extending from the electric/electronic components of the integrated module 5 to be grounded to the vehicle body 3.

The ground system 10 may include a ground bushing 11 mounted on an edge portion 6a of the main bracket 6, and a ground bolt 12 electrically and conductively connecting the ground bushing 11 to the vehicle body 3.

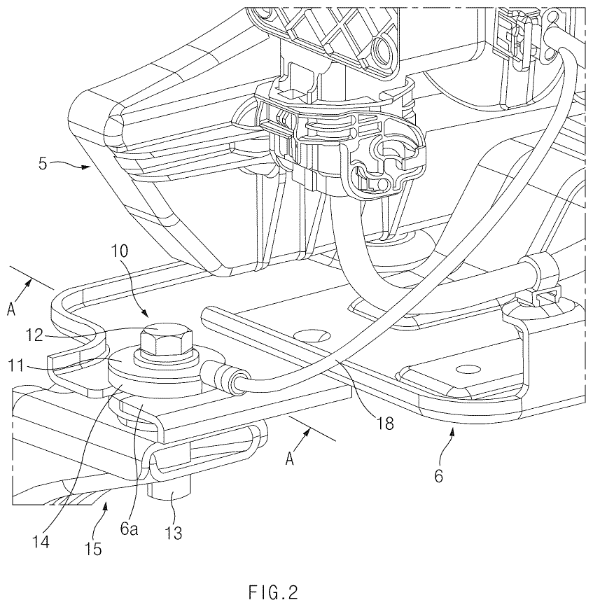

Referring to FIGS. 2 and 4, the ground bushing 11 may be disposed on an overlapped portion of the main bracket 6 and the support bracket 15 (i.e., disposed where the main bracket 6 overlaps the support bracket(s) 15). The edge portion(s) 6a of the main bracket 6 may be overlapped with edge portions of the corresponding support brackets 15. The support brackets 15 may support the main bracket 6, and the ground bushing 11 may be mounted on the edge portion 6a of the main bracket 6.

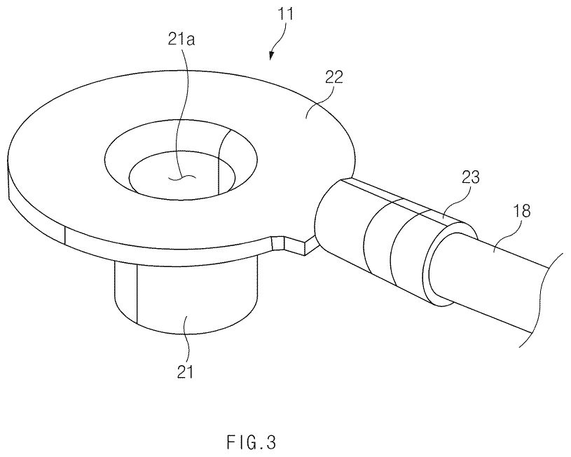

Referring to FIG. 3, the ground bushing 11 may include a cylindrical portion 21 having a hole 21a defined therein, a head portion 22 provided on an end (e.g., a top end) of the cylindrical portion 21, and a connector 23 coupled to (in one example, integrally formed with) the head portion 22. The connector 23 may be coupled (e.g., fixed) to an edge of the head portion 22, and an end of the ground wire 18 may be coupled (e.g., fixed) to the connector 23 so that the ground wire 18 may be electrically connected to the ground bushing 11.

The ground bolt 12 may be configured to fasten the main bracket 6 and the support bracket 15 together. Referring to FIG. 4, a screw portion of the ground bolt 12 may extend through the hole 21a of the ground bushing 11, and a head portion of the ground bolt 12 may contact the head portion 22 of the ground bushing 11. Accordingly, the ground wire 18 may be electrically and conductively connected to the ground bolt 12 through the ground bushing 11.

The ground system 10 may further include a ground nut 13 electrically and conductively connected to the vehicle body 3. The ground nut 13 may be made of a conductor material. The ground nut 13 may include a cylindrical portion 13a, and a head portion 13b provided on an end (e.g., a top end) of the cylindrical portion 13a.

Referring to FIG. 4, the ground nut 13 may be coupled (e.g., fixed) to the support bracket 15 so that the ground nut 13 may be conductively connected to the vehicle body 3 through the support bracket 15. The cylindrical portion 13a may extend through the support bracket 15, and the head portion 13b of the ground nut 13 may be seated on a top surface of the support bracket 15. The ground bushing 11 may be disposed on a top surface of the head portion 13b of the ground nut 13 so that the cylindrical portion 21 of the ground bushing 11 may contact the head portion 13b of the ground nut 13.

The screw portion of the ground bolt 12 may be screwed into the cylindrical portion 13a of the ground nut 13 so that the ground bolt 12 and the ground nut 13 may electrically connect the ground bushing 11 to the support bracket 15. Accordingly, an electric current path CP may be formed along the ground wire 18, the ground bushing 11, the ground bolt 12, the ground nut 13, and the support bracket 15.

Referring to FIG. 4, the ground system 10 may further include an insulator 14 enclosing, or configured to enclose, an outer surface of the cylindrical portion 21 of the ground bushing 11. The insulator 14 may be seated on the top surface of the head portion 13b of the ground nut 13, and the insulator 14 may be mounted on the edge portion 6a of the main bracket 6. Accordingly, the ground bushing 11 may be electrically and conductively insulated from the main bracket 6 through the insulator 14. The ground bolt 12 may be screwed into the ground nut 13 so that the main bracket 6 may be more firmly coupled (e.g., fixed) to the support bracket 15.

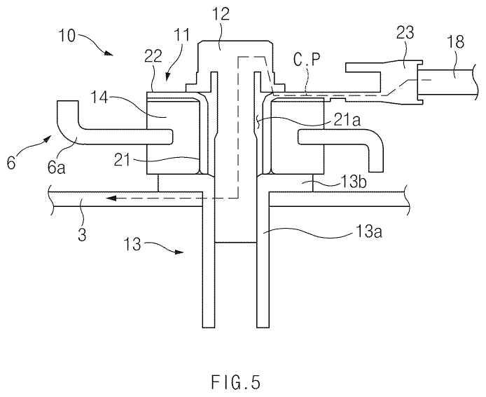

FIG. 5 illustrates a ground system 10 according to another embodiment of the present disclosure. Referring to FIG. 5, the ground nut 13 may be directly coupled (e.g., fixed) to a portion of the vehicle body 3 (for example, a front side member). The cylindrical portion 13a of the ground nut 13 may extend through a portion of the vehicle body 3, and the head portion 13b of the ground nut 13 may be seated on a top surface of a portion of the vehicle body 3. The ground bushing 11 may be disposed on the top surface of the head portion 13b of the ground nut 13 so that the cylindrical portion 21 of the ground bushing 11 may contact the head portion 13b of the ground nut 13.

As set forth above, the ground system according to embodiments of the present disclosure may be designed to have a simple ground structure for the electric/electronic components of the integrated module, thereby improving workability and reducing the cost and weight thereof. In addition, the ground system may be configured to improve electromagnetic compatibility (EMC) of the electric/electronic components, and remove electromagnetic noise.

According to embodiments of the present disclosure, the ground wire extending from the electric/electronic components of the integrated module may be electrically connected to the support bracket through the ground bushing, the ground bolt, and the ground nut so that the ground wire of the electric/electronic components of the integrated module may be grounded to the support bracket, and accordingly the grounding performance of the electric/electronic components of the integrated module may be significantly improved. As the ground bolt is screwed into the ground nut, the main bracket supporting the integrated module may be firmly mounted on the support bracket so that the main bracket may be firmly supported to the support bracket.

Hereinabove, although the present disclosure has been described with reference to embodiments and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. A ground system for an integrated module of a vehicle, the ground system comprising:
a main bracket configured to support the integrated module;
a ground bushing configured to connect to a ground wire extending from the integrated module; and
a ground bolt configured to conductively connect the ground bushing to a vehicle body.

2. The ground system according to claim 1, wherein the ground bushing includes a cylindrical portion having a hole defined therein, a head portion provided on an end of the cylindrical portion, and a connector coupled to the head portion, and
wherein the connector is couplable to an end of the ground wire.

3. The ground system according to claim 2, wherein a screw portion of the ground bolt is configured to extend through the hole of the ground bushing, and
wherein a head portion of the ground bolt is configured to contact the head portion of the ground bushing.

4. The ground system according to claim 1, further comprising a ground nut configured to conductively connect to the vehicle body,
wherein a screw portion of the ground bolt is configured to be screwed into the ground nut.

5. The ground system according to claim 4, wherein the ground nut includes a cylindrical portion and a head portion provided on a top end of the cylindrical portion, and
wherein the ground bushing is configured to contact the head portion of the ground nut.

6. The ground system according to claim 1, further comprising an insulator configured to enclose an outer surface of a cylindrical portion of the ground bushing,
wherein the insulator is configured to be mounted on the main bracket.

7. The ground system according to claim 4, further comprising a support bracket configured to support the main bracket,
wherein the support bracket is configured to be coupled to the vehicle body, and
wherein the ground nut is configured to be coupled to the support bracket.

8. The ground system according to claim 4, wherein the ground nut is configured to be directly coupled to the vehicle body.

9. The ground system according to claim 2, wherein the connector is integrally formed with the head portion.

10. The ground system according to claim 2, wherein the connector is configured to be fixed to the end of the ground wire.

11. The ground system according to claim 2, wherein the head portion of the ground bushing is provided on a top end of the cylindrical portion of the ground bushing.

12. A vehicle, comprising:
a vehicle body;
an integrated module;
a ground wire extending from the integrated module;
a main bracket supporting the integrated module;
a ground bushing connected to the ground wire; and
a ground bolt conductively connecting the ground bushing to the vehicle body.
